(19) United States
(12) Patent Application Publication
(10) Pub. No.: US 2013/0176279 A1
(43) Pub. Date: Jul. 11, 2013

(54) CAPACITIVE TOUCH PANEL AND TOUCH DISPLAY PANEL USING THE SAME

(71) Applicants: HengHao Technology Co. LTD, Taoyuan County (TW); Kuang-Ta Chen, Taoyuan County (TW); Kuang-Ta Chen, Taoyuan County (TW)

(72) Inventors: Ting-Chieh Chen, Taoyuan County (TW); Ming-Hsi Wang, New Taipei City (TW); Yu-Jen Chen, Pingtung County (TW)

(73) Assignee: HengHao Technology Co. LTD., Taoyuan County (TW)

(21) Appl. No.: 13/708,172

(22) Filed: Dec. 7, 2012

(30) Foreign Application Priority Data
Jan. 11, 2012 (TW) 101200697

(51) Int. Cl. G06F 3/044

(52) U.S. Cl. CPC G06F 3/044
USPC 345/174

(57) ABSTRACT

A capacitive touch panel and a touch display panel using the same are provided. The capacitive touch panel includes a substrate, a plurality of sensing structures and a light shading structure. The substrate has a first surface and a second surface opposite to the first surface. The sensing structures are formed on the first surface of the substrate and each sensing structure includes a plurality of sensing units and a plurality of bridge wires, wherein two adjacent sensing units are connected by the corresponding bridge wire. The light shading structures are formed on the first surface of the substrate, wherein a region of the light shading structures correspond to a region of the bridge wires, and a proportion of a first distribution area of each light shading structure to a second distribution area of the corresponding bridge wire is greater than 30%.

### CROSS-REFERENCE TO RELATED APPLICATIONS

The entire contents of Taiwan Patent Application No. 101200697, filed on Jan. 11, 2012, from which this application claims priority, are incorporated herein by reference.

### BACKGROUND OF THE INVENTION

1. Field of the Invention

The invention relates in general to a capacitive touch panel and a touch display panel using the same, and more particularly to a capacitive touch panel capable of reducing the reflection of the light and a touch display panel using the same.

2. Description of Related Art

In a conventional capacitive touch panel, each sensing structure includes a plurality of metal bridge wires and a plurality of sensing units, and one metal bridge wire connects two adjacent sensing units. Therefore, in each sensing structure, the metal bridge wires are electrically connected to the sensing units.

The bridge wires are directly formed on the substrate. The bridge wires are made from metal and form a metal structure which causes the light entering the metal bridge wires to generate strong reflection, which results in visual discomfort to the user.

### SUMMARY OF THE INVENTION

The invention is directed to a capacitive touch panel and a touch display panel using the same capable of reducing reflectivity and improving displaying quality.

According to an embodiment of the present invention, a capacitive touch panel is provided. The capacitive touch panel includes a substrate, a plurality of sensing structures and a light shading structure. The substrate has a first surface and a second surface opposite to the first surface. The sensing structures are formed on the first surface of the substrate and each sensing structure includes a plurality of sensing units and a plurality of bridge wires, wherein two adjacent sensing units are connected by the corresponding bridge wire. The light shading structures are formed on the first surface of the substrate, wherein a region of the light shading structures correspond to a region of the bridge wires, and a proportion of a first distribution area of each light shading structure to a second distribution area of the corresponding bridge wire is greater than 30%.

According to another embodiment of the present invention, a touch display panel is provided. The touch display panel includes a casing, a display panel and a capacitive touch panel. The capacitive touch panel is configured in the casing and includes a substrate, a plurality of sensing structures and a light shading structure. The substrate has a first surface and a second surface opposite to the first surface. The sensing structures are formed on the first surface of the substrate, and each sensing structure includes a plurality of sensing units and a plurality of bridge wires, wherein two adjacent sensing units are connected by the corresponding bridge wire. The light shading structures are formed on the first surface of the substrate, wherein a region of the light shading structures correspond to a region of the bridge wires, and a proportion of a first distribution area of each light shading structure to a second distribution area of the corresponding bridge wire is greater than 30%.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional view of a touch display panel according to an embodiment of the invention;

FIG. 2 shows a top view of the capacitive touch panel of FIG. 1;

FIG. 3 shows a cross-sectional view along the direction 3-3′ of FIG. 1;

FIG. 4 shows a cross-sectional view along the direction 4-4′ of FIG. 2;

FIG. 5 shows a top view of the first bridge wire and the light shading structure of FIG. 3;

FIG. 6 to FIG. 11B respectively show cross-sectional views of a light shading structure according to other embodiments of the invention;

FIG. 12 shows a top view of the capacitive touch panel according to another embodiment of the invention;

FIG. 13 shows a cross-sectional view along the direction 13-13′ of FIG. 12; and

FIG. 14 shows a cross-sectional view along the direction 14-14′ of FIG. 12.

### DETAILED DESCRIPTION OF THE INVENTION

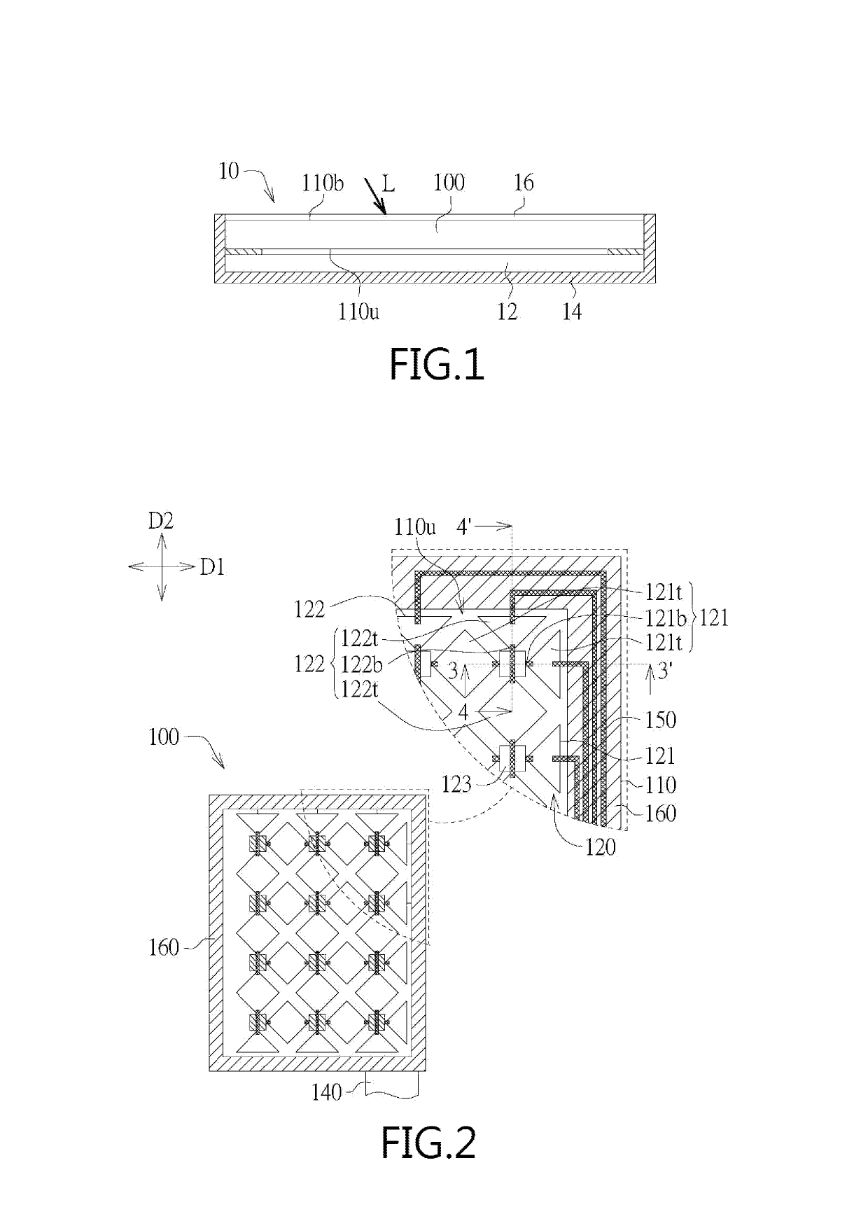

Referring to FIG. 1, a cross-sectional view of a touch display panel according to an embodiment of the invention is shown. The touch display panel 10 is such as a hand-held electronic device, a notebook computer and a Tablet PC. The hand-held electronic device is such as a mobile, smart phone, a personal digital assistant (PDA) or a navigation device.

The touch display panel 10 includes a capacitive touch panel 100, a display panel 12, a casing 14 and a protective film 16.

The display panel 12 is configured into the casing 14. The display panel 12 is configured in correspondence with the capacitive touch panel 100, and the display panel 12 may be realized by any type of display panels such as a liquid crystal display, an electrophoretic display or an organic light-emitting diode (OLED) display.

The protective film 16 covers the capacitive touch panel 100, being capable of protecting the capacitive touch panel 100. Furthermore, the material of the protective film 16 may include silicon oxide, magnesium fluoride, aluminum oxide or yttrium oxide.

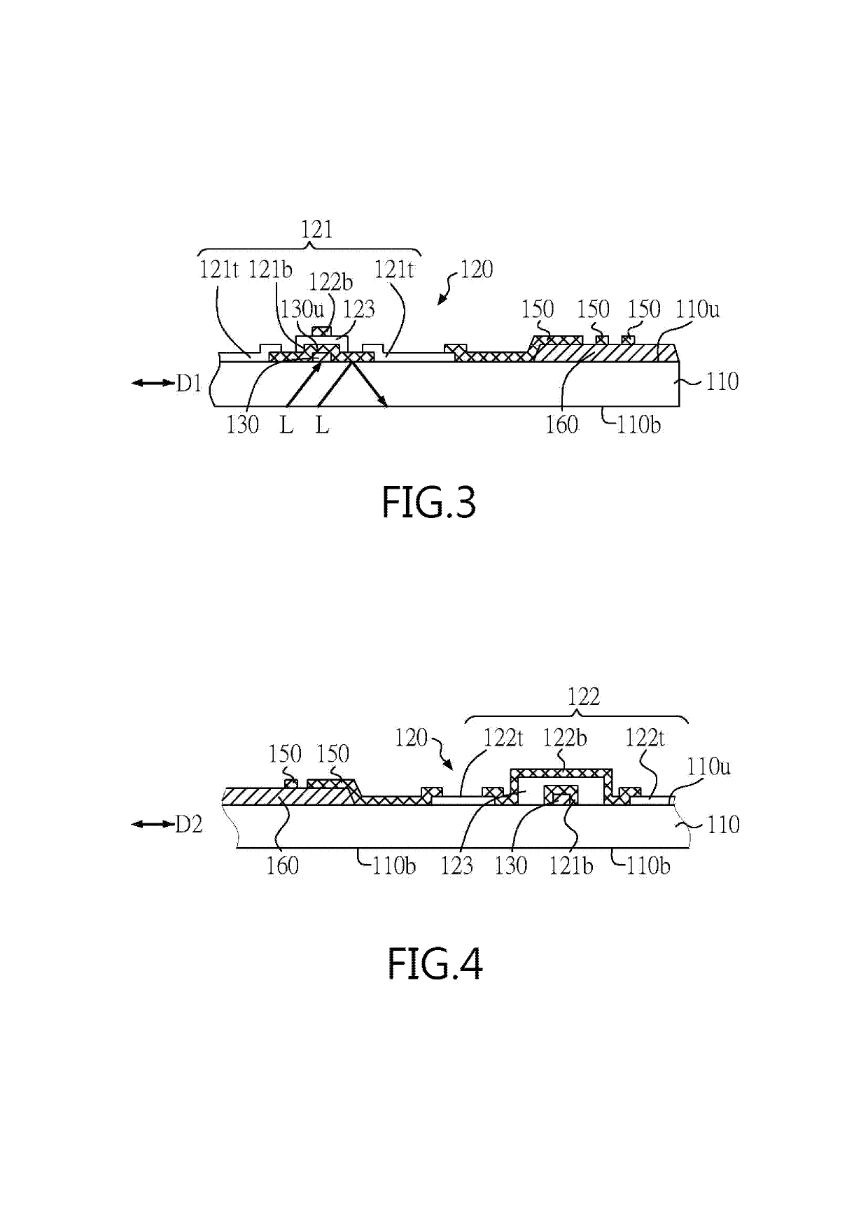

Referring to FIG. 2, FIG. 2 shows a top view of the capacitive touch panel of FIG. 1. The capacitive touch panel 100 is configured into the casing 14. The capacitive touch panel 100 includes a substrate 110, a plurality of sensing structures 120 and a plurality of light shading structures 130 (shown in FIG. 3). Moreover, the touch display panel 10 may be used in various electronic devices requiring the touch function.

The capacitive touch panel 100 may include a plurality of signal transmission lines 150 and a circuit board 140. The signal transmission lines 150 are connected to the sensing structures 120 and the circuit board 140, so as to transmit the sensing signal from the sensing structures 120 to the circuit board 140.

The substrate 110 is a transparent the substrate, made from a high transmittance insulating material, such as glass, polycarbonate (PC), polythylene terephthalate (PET), polymethylmethacrylate (PMMA) or cyclic olefin copolymer.

The substrate 110 has a first surface 110u and a second surface 110b opposite to the first surface 110u (the second surface 110b shown in FIG. 3).

The sensing structures 120 are formed on the first surface 110u of the substrate 110. Each sensing structure 120 includes a plurality of sensing units and a plurality of bridge wires, and two adjacent sensing units are connected by the corresponding bridge wire. For example, in the present embodiment, the sensing structures 120 include a plurality of first sensing structures 121 and a plurality of second sensing structures 122, wherein each first sensing structure 121 is arranged along the first direction D1, and each second sensing structure 122 is arranged along the second direction D2.

Referring to FIG. 3, FIG. 3 shows a cross-sectional view along the direction 3-3′ of FIG. 1. Each first sensing structure 121 includes a plurality of first bridge wires 121b and a plurality of first sensing units 121t (FIG. 3 only showing a single first bridge wire 121b and a single first sensing unit 121t), wherein two adjacent first sensing units 121t are connected by the corresponding first bridge wire 121b.

In the present embodiment of the invention, the first sensing units 121t are made from such as a transparent conductive oxide (TCO) or a transparent organic conductive material. The transparent conductive material is such as indium tin oxide (ITO) or indium zinc oxide (IZO), and the transparent organic conductive material is such as Poly (3, 4-ethylenedioxythiophene) poly (styrenesulfonate) (PEDOT).

The first bridge wires 121b are made from such as a transparent conductive material or a metal selected from a group consisting of titanium, aluminum, molybdenum, copper, silver and a combination thereof. In one embodiment, the first bridge wires 121b are made of molybdenum/aluminum/molybdenum or titanium/aluminum/titanium.

Referring to FIG. 4, FIG. 4 shows a cross-sectional view along the direction 4-4′ of FIG. 2. Each second sensing structure 122 includes a plurality of second bridge wires 122b and a plurality of second sensing units 122t. Two adjacent second sensing units 122t are connected by the corresponding second bridge wire 122b. The material of the second sensing units 122t may be similar to that of the first sensing units 121t, and therefore the similarities are not repeated here. The structure of second bridge wires 122b may be similar to that of the first bridge wires 121b, and the similarities are not repeated here.

As indicated in FIG. 4, the sensing structure 120 further includes an isolation layer 123. The isolation layer 123 electrically isolates the first bridge wires 121b and the second bridge wires 122b in order to avoid the first bridge wires 121b from being contacted by the corresponding second bridge wires 122b, which may result in a short circuit. In addition, the insulation layer 123 may be realized by an insulation layer either permeable or impermeable to the light.

As indicated in FIG. 4, the capacitive touch panel 100 further includes a marginal light shading layer 160, which is formed on the first surface 110u of the substrate 110 and situated on the marginal region of the substrate 110. In the present embodiment, the marginal light shading layer 160 is directly formed on the first surface 110u of the substrate 110. The signal transmission lines 150 mentioned above are extended to the external surface 160u of the marginal light shading layer 160. In another embodiment, the signal transmission lines 150 mentioned above may be directly formed on the first surface 110u of the substrate 110. The marginal light shading layer 160 covers the signal transmission lines 150. In another embodiment, the marginal light shading layer 160 may also be formed on the second surface 110b of the substrate 110. In this design, the signal transmission lines 150 mentioned above and the marginal light shading layer 160 are isolated by the substrate 110.

In the present embodiment, the light shading structure 130 is directly formed on the first surface 110u of the substrate 110. The light shading structure 130 is arranged along the first direction D1 (the first direction D1 shown in FIG. 3). That is, the direction of the major axis of the light shading structures 130 is extended along the first direction D1. Furthermore, the first bridge wires 121b cover all the corresponding light shading structures 130. In this embodiment, the first bridge wires 121b directly cover (or contact) all the corresponding light shading structures 130.

The distribution area of the light shading structure 130 is corresponding to the first bridge wire 121b, and a proportion of a first distribution area of each light shading structure to a second distribution area of the corresponding bridge wire is at least greater than 30%. Due to the light shading property of the light shading structure 130, when the light L is incident from the second surface 110b into the light shading structure 130, the reflection will not be caused or only a little reflection will be caused. Consequently, the reflection may be reduced and the displaying quality could be improved as well. (When the capacitive touch panel 100 is configured into the casing 14, the second surface 110b of the substrate 110 is facing outward of the casing 14, such that the light L may be incident from the second surface 110b of the substrate 110 into the substrate 110, the light shading structure 130 and the sensing structures 120.)

In an embodiment, the proportion of the first distribution area (light shading structure) to the second distribution area (bridge wire) may be between about 30% to 80%. On the condition that the color of the light shading structure is darker than the color of the bridge wire, as proportion of the first distribution area to the second distribution area is not 100%, the distribution of the light shading structure 130 may be unobvious in the appearance, which will not influence the displaying quality.

In another embodiment, if the color of the light shading structure 130 is properly chosen, the proportion of the first distribution area to the second distribution area may be designed to be 100%. In this design, the first bridge wires 121b only cover the upper surface 130u of the light shading structure 130 (When the capacitive touch panel 100 is configured in the casing14, the upper surface 130u is facing the internal part of the casing 14.), but the first bridge wires 121b does not cover the side surface of the light shading structure 130. In another embodiment, the first bridge wires 121b may cover the upper surface 130u and the side surface of the light shading structure 130, but the volume proportion of the part of the side surface covered by the light shading structure 130 to the part of the upper surface 130u covered by the light shading structure 130 is relatively small, such as being under 2%.

The light shading structure 130 and the marginal light shading layer 160 are made of the material such as chromium, photoresist material, black resin, nickel, tungsten, or ink, etc. The present invention does not limit the material of the light shading structure 130, as long as the light shading structure 130 may reduce the reflection rate. In a preferred but non-limiting embodiment, the light shading structure 130 is made of the high temperature material. Therefore, in the high temperature process of forming the first sensing structures 121 and/or the second sensing structures 122, the light shading structure 130 made of the high temperature material may withstand the high temperatures without melting or softening. In an embodiment, the softening point of the light shading structure 130 is higher than the processing degree of the sensing structure 120. For example, the temperature is higher than 200 degrees Celsius. (For example, in the sputtering process of forming the first sensing structures 121 and the second sensing structures 122, the sputtering temperature is usually higher than 200 degrees Celsius.) In another embodiment, when the manufacturing process of forming the first sensing structures 121 and/or the second sensing structures 122 is changed, the material of the light shading structure 130 is not limited to the high temperature material.

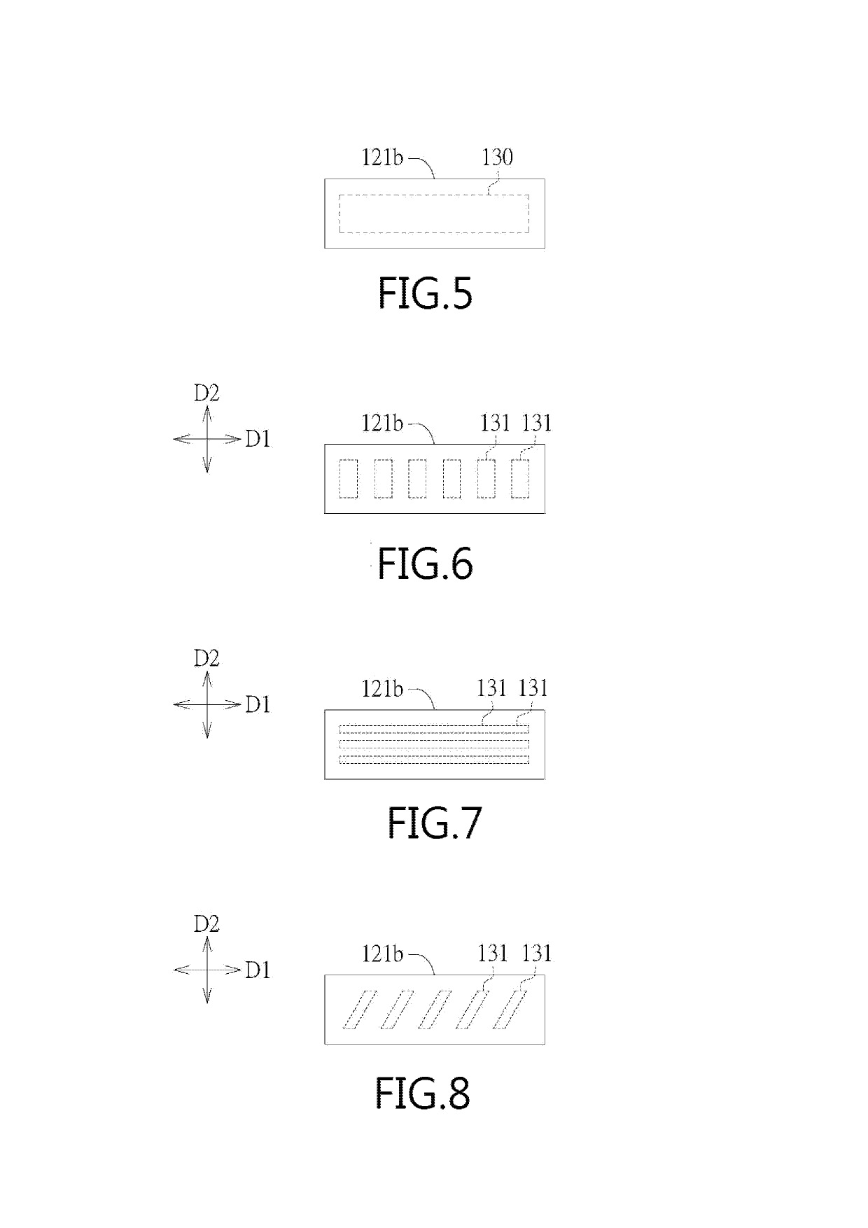

Referring to FIG. 5, FIG. 5 shows a top view of the first bridge wire and the light shading structure in FIG. 3. The light shading structure 130 is a single long light shading structure.

Referring to FIG. 6 to FIG. 11B, FIG. 6 to FIG. 11B respectively show top views of the first bridge wire and the light shading structure according to other embodiments of the invention.

As indicated in FIG. 6 and FIG. 7, each light shading structure 130 includes a plurality of long light shading structures 131. The long light shading structure 131 are parallel or perpendicular to the first direction D1 (FIG. 6) or the second direction D2 (FIG. 7).

As indicated in FIG. 8, the long light shading structures 131 are skewed relative to the first direction D1 or the second direction D2.

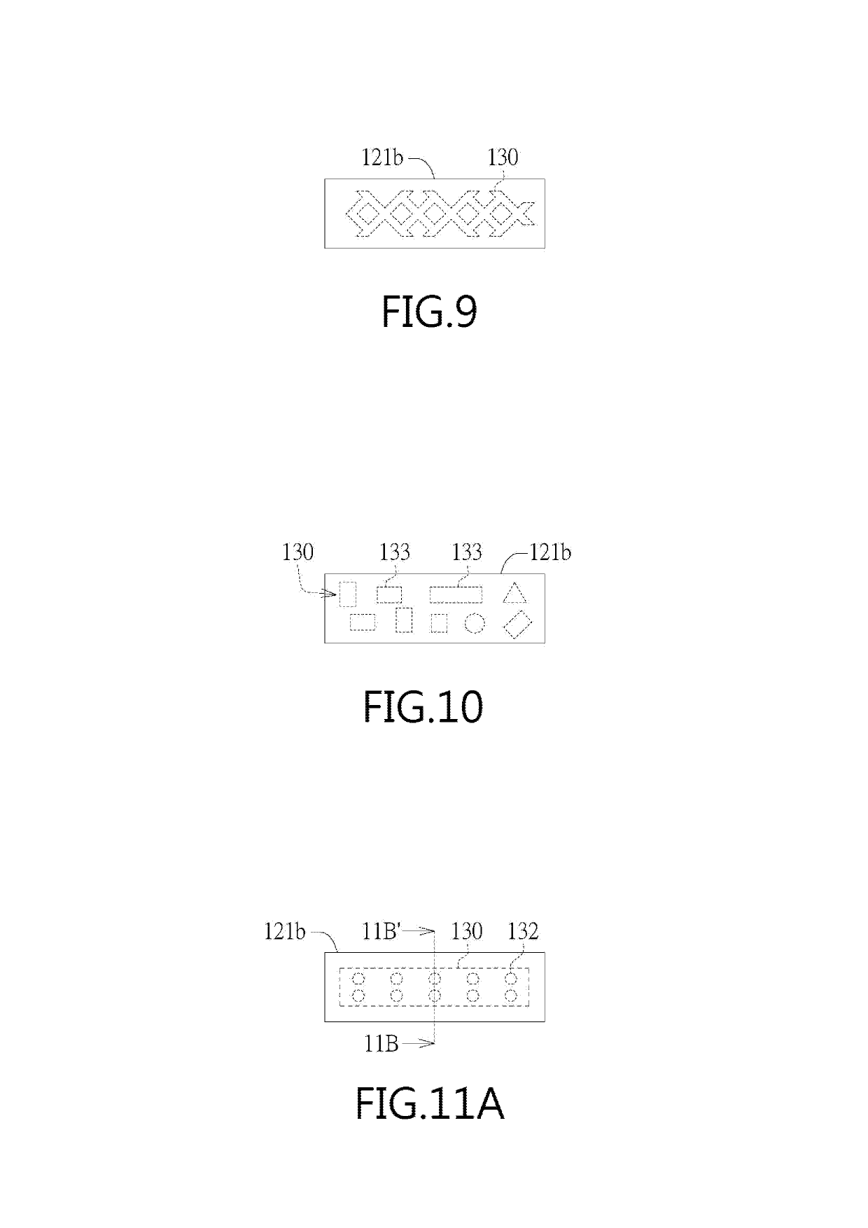

As indicated in FIG. 9, the light shading structure 130 is a patterned light shading layer. In the present embodiment, the light shading structure 130 is a network structure.

As indicated in FIG. 10, the light shading structure 130 includes a plurality of light shading blocks 133, and the light shading blocks 133 are separately arranged. The shapes of the cross-sections of the light shading blocks 133 include at least one of circular, rectangular, triangular, polygonal and elliptical shape. The shapes of the cross-sections light shading blocks 133 may be completely the same or all different.

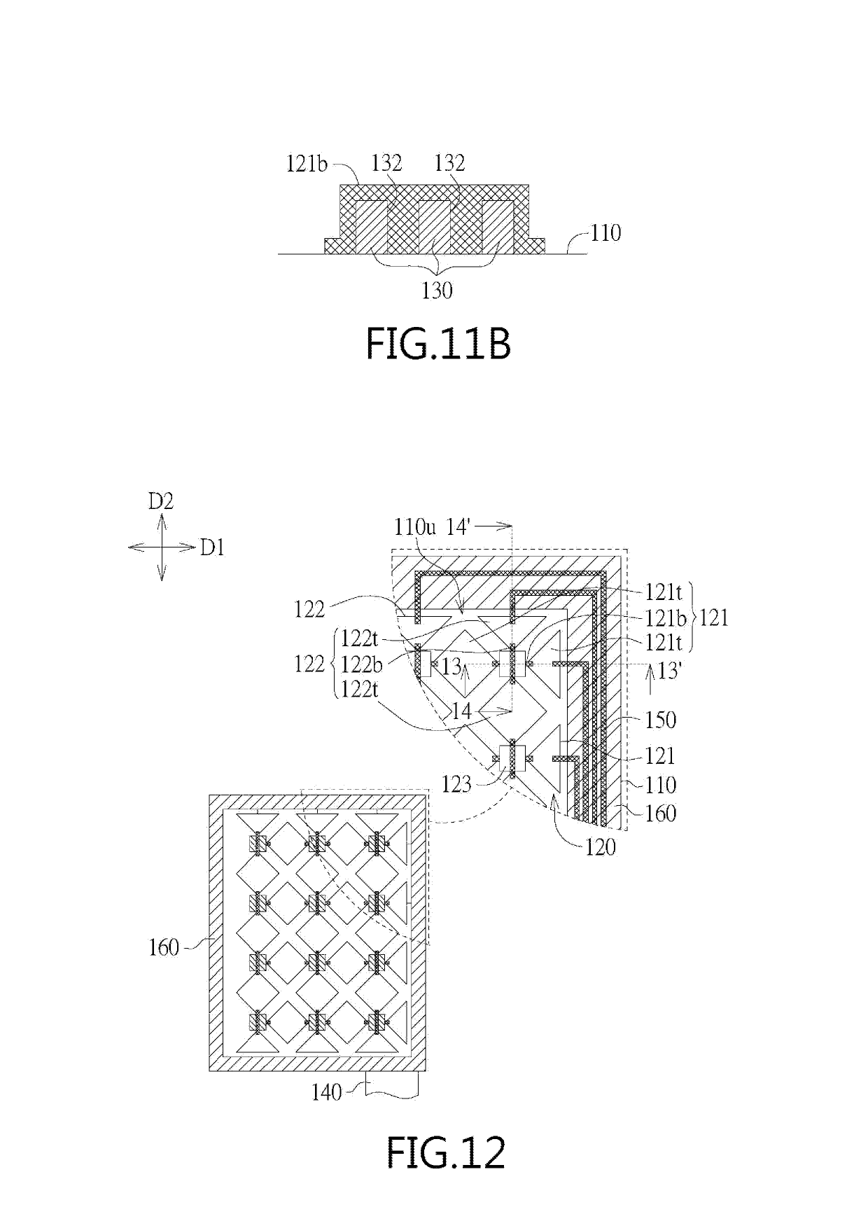

As indicated in FIG. 11A and FIG. 11B, FIG. 11B shows a cross-sectional view along the direction 11B-11B′ of FIG. 11A. The light shading structure 130 is the patterned light shading layer. In the present embodiment, the light shading structure 130 has at least one via hole 132. The first bridge wire 121b can be filled in the via hole 132.

According to the above description, the present invention does not limit the geometry structure of the light shading structure 130, as long as the portion of the distribution area of the light shading structure 130 to the distribution area of the corresponding bridge wire is greater than 30%.

The following describes one of manufacturing methods of the capacitive touch panel 100.

Firstly, the coating process, for example, is used to form a plurality of light shading structures 130 and a marginal light shading layer 160 on the first surface 110u of the substrate 110. The coating processes are such as printing, spinning or spraying. In a preferred but non-limiting embodiment, the light shading structure 130 and the marginal light shading layer 160 are made of the high temperature material. In another embodiment, the marginal light shading layer 160 and the light shading structures 130 may be formed in different manufacturing processes. For example, the marginal light shading layer 160 may be formed after the signal transmission lines 150, such that the marginal light shading layer 160 may cover the signal transmission lines 150. In another embodiment, the marginal light shading layer 160 may be formed on the second surface 110b of the substrate 110, such that the marginal light shading layer 160 and the signal transmission lines 150 may be isolated by the substrate 110.

Then, in the same process, the first bridge wires 121b are formed to cover all the corresponding light shading structures 130, and the signal transmission lines 150 are formed to extend to the marginal light shading layer 160. In another embodiment, the signal transmission lines 150 and the second bridge wires 122b may be formed in different processes.

In this step, the manufacturing process such as sputtering may be used to form all the material of the bridge wires, and then the photolithography process may be used to pattern the material of the bridge wires, so as to form the first bridge wires 121b shown in FIG. 2.

Then, in the same process, the first sensing units 121t and the second sensing units 122t are formed, and two adjacent first sensing units 121t are connected by the corresponding first bridge wire 121b. In another embodiment, the first sensing units 121t and the second sensing units 122t may be formed in different processes.

In this step, the manufacturing process such as sputtering may be used to form all material of the sensing units, and then the photolithography process may be used to pattern the material of the sensing units, so as to form the first sensing units 121t and the second sensing units 122t shown in FIG. 2.

Afterwards, the coating process, for example, is used to form the isolation layer 123, which covers the first bridge wires 121b.

Then, the second bridge wires 122b are formed on the isolation layer 123, and two adjacent second sensing units 122t are connected by the corresponding second bridge wire 122b. The manufacturing process of the second bridge wires 122b is similar to that of the first bridge wire 121b, and the similarities are not repeated here.

Referring to FIG. 12, FIG. 12 shows a top view of the capacitive touch panel according to another embodiment of the invention. The capacitive touch panel 200 includes a substrate 110, a plurality of sensing structures 120, a plurality of light shading structures 130, a circuit board 140 and a marginal light shading layer 160. Furthermore, the capacitive touch panel 200 may be used in various electronic devices requiring the touch function.

The sensing structures 120 include a plurality of first sensing structures 121 and a plurality of second sensing structures 122. The first sensing structures 121 are arranged along the first direction D1, and the second sensing structures 122 are arranged along the second direction D2.

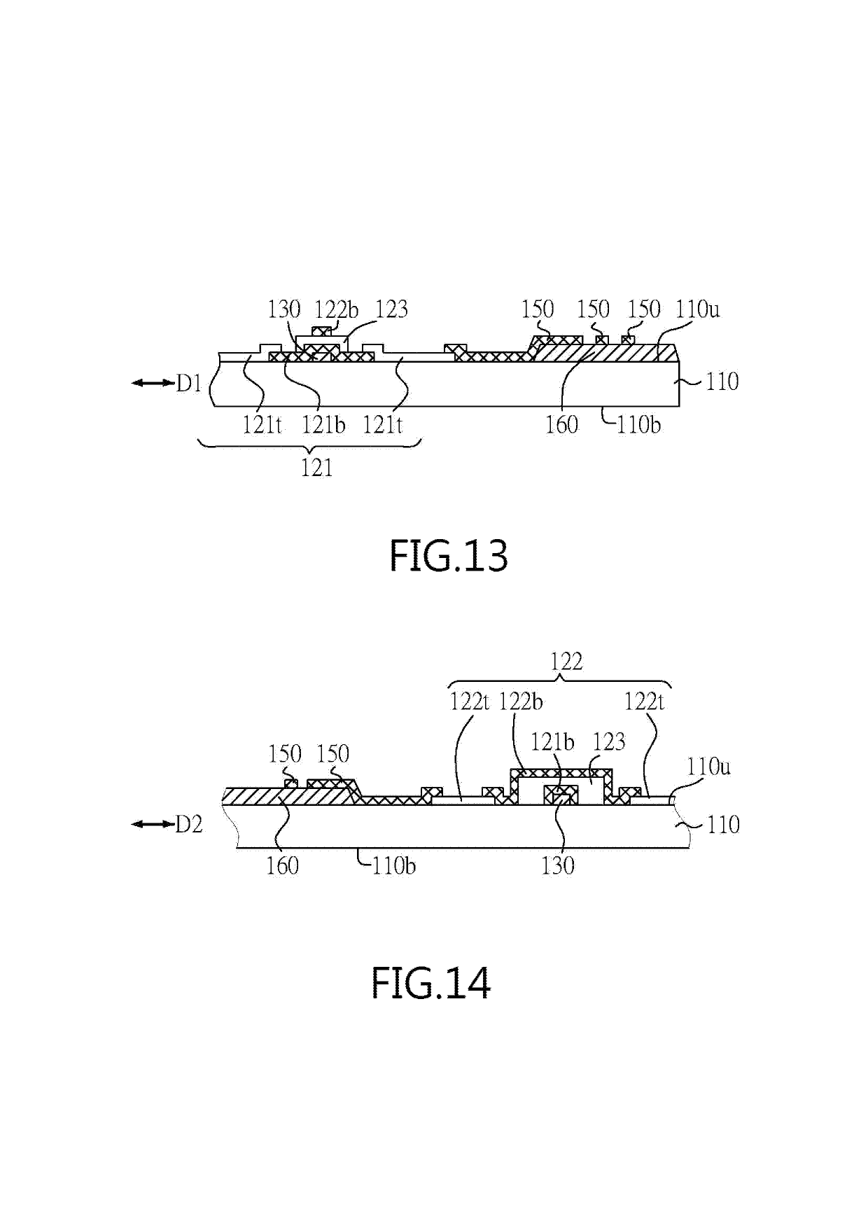

Referring to FIG. 13, FIG. 13 shows a cross-sectional view along the direction 13-13′ of FIG. 12. The light shading structures 130 are extended along the first direction D1. Each first sensing structure 121 includes a plurality of first bridge wires 121b and a plurality of first sensing units 121t, and two adjacent first sensing units 121t are connected by the corresponding first bridge wire 121. The first bridge wires 121b cover all corresponding light shading structures 130. In this embodiment, the first bridge wires 121b directly cover a portion of the corresponding light shading structures 130 (such as the opposite ends of the light shading structure 130), so as to indirectly cover another portion of the corresponding light shading structures 130 (such as the portion between the opposite ends of the light shading structure 130). In another embodiment, when the isolation layer 123 completely covers the light shading structures 130, the first bridge wires 121b indirectly cover all the corresponding light shading structures 130. (That is, the first bridge wires 121b and the light shading structures 130 are isolated by the isolation layer123.)

Referring to FIG. 14, FIG. 14 shows a cross-sectional view along the direction 14-14′ of FIG. 12. Each second sensing structure 122 includes a plurality of second bridge wires 122b and a plurality of second sensing units 122t, and two adjacent second sensing units 122t are connected by the corresponding second bridge wire 122b. The second bridge wires 122b are directly formed on the light shading structures 130.

One manufacturing method of the capacitive touch panel 200 includes the following steps.

Firstly, the coating process, for example, is used to form a plurality of light shading structures 130 and a marginal light shading layer 160 on the first surface 110u of the substrate 110.

Then, the second bridge wires 122b are formed on the corresponding light shading structures 130. In the present embodiment, the second bridge wires 122b cover a portion of the corresponding light shading structures 130. In the same process, which is used to form the second bridge wires 122b, the signal transmission lines 150 are formed to extended to the marginal light shading layer 160. In another embodiment, the signal transmission lines 150 and the first bridge wires 121b may be formed in the different manufacturing processes.

In this step, the manufacturing process such as sputtering may be used to form all the material of the bridge wires, and then the photolithography process may be used to pattern the material of the bridge wires, so as to form the second bridge wires 122b shown in FIG. 12.

Then, in the same process, the first sensing units 121t and the second sensing units 122t are formed, and two adjacent first sensing units 121t are connected by the corresponding first bridge wire 121b. In another embodiment, the first sensing units 121t and the second sensing units 122t may be formed in different manufacturing processes.

In this step, the manufacturing process such as sputtering may be used to form all the material of the sensing units, and then the photolithography process may be used to pattern the material of the sensing units, so as to form the first sensing units 121t and the second sensing units 122t shown in FIG. 12.

Afterwards, the coating process, for example, is used to form the isolation layer 123, which covers the second bridge wires 122b.

Then, the first bridge wires 121b are formed on the isolation layer 123, and two adjacent first sensing units 121t are connected by the corresponding first bridge wire 121b. The manufacturing process of the first bridge wires 121b is similar to that of the second bridge wire 122b, and the similarities are not repeated here.

The capacitive touch panel and the touch display panel using the same, which are disclosed in above embodiments of the present invention, may decrease the reflection rate and improve the displaying quality.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A capacitive touch panel, comprising:
a substrate, having a first surface and a second surface opposite to the first surface;
a plurality of sensing structures, formed on the first surface of the substrate and each sensing structure comprising a plurality of sensing units and a plurality of bridge wires, wherein two adjacent sensing units are connected by the corresponding bridge wire; and
a plurality of light shading structures, formed on the first surface of the substrate, wherein a region of the light shading structures corresponds to a region of the bridge wires, and a proportion of a first distribution area of each light shading structure to a second distribution area of the corresponding bridge wire is greater than 30%.

2. The capacitive touch panel according to claim 1, wherein each light shading structure comprises a long light shading structure.

3. The capacitive touch panel according to claim 1, wherein each light shading structure comprises a plurality of light shading blocks, and the light shading blocks are separately arranged.

4. The capacitive touch panel according to claim 1, wherein each light shading structure is a patterned light shading layer.

5. The capacitive touch panel according to claim 1, wherein each light shading structure is made of chromium, photoresist material, black resin, nickel, tungsten, or ink.

6. The capacitive touch panel according to claim 1, wherein each light shading structure is arranged along a first direction, the sensing structures comprising:
a plurality of first sensing structures, each first sensing structure being arranged along the first direction and comprising:
a plurality of first bridge wires, each first bridge wire being directly formed and covering the corresponding light shading structure; and
a plurality of first sensing units, two adjacent first sensing units being connected by a corresponding first bridge wire; and
a plurality of second sensing structures, each second sensing structure being arranged along a second direction and comprising:
a plurality of second bridge wires; and
a plurality of second sensing units, two adjacent second sensing units being connected by the corresponding second bridge wire.

7. The capacitive touch panel according to claim 6, wherein each sensing structure further comprises:
an isolation layer, electrically isolating the first bridge wires and the second bridge wires.

8. The capacitive touch panel according to claim 1, further comprising:
a marginal light shading layer, formed on the first surface of the substrate and situated on a marginal region of the substrate.

9. The capacitive touch panel according to claim 8, further comprising:
a plurality of signal transmission lines, being extended to an external surface of the marginal light shading layer and each signal transmission line being connected to the corresponding sensing structure.

10. The capacitive touch panel according to claim 8, further comprising:
a plurality of signal transmission lines, formed on the first surface of the substrate and the marginal light shading layer covering the signal transmissions.

11. A touch display panel, comprising:
a casing;
a display panel, configured in the casing; and
a capacitive touch panel, configured in the casing, and comprising:
a substrate, having a first surface and a second surface opposite to the first surface;
a plurality of sensing structures, formed on the first surface of the substrate and each sensing structure comprising a plurality of sensing units and a plurality of bridge wires, wherein two adjacent sensing units are connected by the corresponding bridge wire; and
a plurality of light shading structures, formed on the first surface of the substrate, wherein a region of the light shading structures corresponds to a region of the bridge wires, and a proportion of a first distribution area of each light shading structure to a second distribution area of the corresponding bridge wire is greater than 30%.

12. The touch display panel according to claim 11, wherein each light shading structure comprises a long light shading structure.

13. The touch display panel according to claim 11, wherein each light shading structure comprises a plurality of light shading blocks, and the light shading blocks are separately arranged.

14. The touch display panel according to claim 11, wherein each light shading structure is a patterned light shading layer.

15. The touch display panel according to claim 11, wherein each light shading structure is made of chromium, photoresist material, black resin, nickel, tungsten, or ink.

16. The touch display panel according to claim 11, wherein each light shading structure is arranged along a first direction, the sensing structures comprising:
a plurality of first sensing structures, each first sensing structure being arranged along the first direction and comprising:
a plurality of first bridge wires, each first bridge wire being directly formed on and covering the corresponding light shading structure; and
a plurality of first sensing units, two adjacent first sensing units being connected by a corresponding first bridge wire; and
a plurality of second sensing structures, each second sensing structure being arranged along a second direction and comprising:
a plurality of second bridge wires; and
a plurality of second sensing units, two adjacent second sensing units being connected by a corresponding the second bridge wire.

17. The touch display panel according to claim 16, further comprising:
a marginal light shading layer, formed on the first surface of the substrate and situated on a marginal region of the substrate.

18. The touch display panel according to claim 11, further comprising:
a marginal light shading layer, formed on the first surface of the substrate and situated on a marginal region of the substrate.

19. The touch display panel according to claim 18, further comprising:
a plurality of signal transmission lines, being extended to an external surface of the marginal light shading layer and each signal transmission line being connected to the corresponding sensing structure.

20. The touch display panel according to claim 18, further comprising:
a plurality of signal transmission lines, formed on the first surface of the substrate and the marginal light shading layer covering the signal transmissions.
